(19) United States
(12) Patent Application Publication
(10) Pub. No.: US 2023/0156296 A1
(43) Pub. Date: May 18, 2023

(54) SYSTEMS AND METHODS FOR TEMPORALLY RESTRICTING ACCESS TO MULTIMEDIA

(71) Applicant: Sling TV L.L.C., Englewood, CO (US)

(72) Inventors: Seth VanSickel, Parker, CO (US); Marc A. Paladino, Highlands Ranch, CO (US)

(21) Appl. No.: 18/054,477

(22) Filed: Nov. 10, 2022

Related U.S. Application Data
(60) Provisional application No. 63/281,025, filed on Nov. 18, 2021.

(51) Int. Cl. H04N 21/8355; H04N 21/442; H04N 21/472

(52) U.S. Cl. CPC H04N 21/8355; H04N 21/44204; H04N 21/47211

(57) ABSTRACT

The present disclosure is directed to systems and methods for permitting and restricting access to multimedia items based on temporal restrictions associated with certain subscription levels. The subscriptions may be subscriptions to broadcast/satellite television programming and/or Internet-streaming services. The temporal limitations on the subscription may be based on days of the week, time of day, and/or particular types of content that air at certain times. For example, one subscription type may be a weekend-only subscription that permits a user to access certain multimedia items on the weekend but restricts access to those same multimedia items during the week. A machine-learning model that is trained on a user's past viewing history is also disclosed. The system may rely on the machine-learning model to present certain relevant restricted multimedia items to the user that the user can access if the user, e.g., upgrades a subscription and/or remits a one-time fee.

### CROSS-REFERENCE TO RELATED APPLICATION

This application claims priority to and the benefit of U.S. Provisional Patent Application No. 63/281,025, filed on Nov. 18, 2021, entitled “SYSTEMS AND METHODS FOR TEMPORALLY RESTRICTING ACCESS TO MULTIMEDIA,” which is incorporated herein by reference in its entirety.

### TECHNICAL FIELD

The present disclosure is related to the field of digital rights management.

### BACKGROUND

Television programming and multimedia subscription services are often provided to customers in an all-or-nothing format: either a customer must subscribe to the entire package of digital content (e.g., channels) or subscribe to nothing at all. One of the reasons for this current structure in broadcast programming and Internet streaming services is the relative ease of implementing a digital rights management (“DRM”) scheme to control this binary subscription structure. A DRM system merely needs to check whether a certain customer has access to the selected programming or not. As a result of this subscription structure, many customers are forced into an all-or-nothing decision for subscribing to broadcast programming and/or Internet streaming. Customers who may not necessarily consume as much multimedia content as other customers may consume a disproportionate amount of multimedia resources relative to the amount of multimedia they consume. In other words, technical resources associated with broadcast programming and Internet streaming management must always provide access to certain programming, even though the customer is not consuming the multimedia at certain times, and/or the multimedia that is available to consume at certain times is not relevant to the customer's preferences. Modern multimedia DRM schemes fail to account for these alternative customer behaviors and alternative subscription schemes. As such, there is an increased need for systems and methods that can address the challenges of present-day multimedia subscription models and paradigms.

It is with respect to these and other general considerations that the aspects disclosed herein have been made. Also, although relatively specific problems may be discussed, it should be understood that the examples should not be limited to solving the specific problems identified in the background or elsewhere in the disclosure.

### BRIEF DESCRIPTION OF THE DRAWINGS

Non-limiting and non-exhaustive examples are described with reference to the following figures.

FIG. 1 illustrates an example of a distributed system for temporally restricting access to multimedia, as described herein.

FIG. 2 illustrates an example input processor that is configured to implement the systems and methods described herein.

FIG. 3 illustrates an example method for temporally restricting multimedia.

FIG. 4 illustrates an example electronic program guide indicating accessibility of certain multimedia items based on the systems and methods disclosed herein.

FIG. 5 illustrates an example display device with an electronic program guide indicating accessibility of certain multimedia items based on the systems and methods disclosed herein.

FIG. 6 illustrates one example of a suitable operating environment in which one or more of the present embodiments may be implemented.

### DETAILED DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems, or devices. Accordingly, aspects may take the form of a hardware implementation, an entirely software implementation or an implementation combining software and hardware aspects. The following detailed description is, therefore, not to be taken in a limiting sense.

Embodiments of the present application are directed at systems and methods associated with temporally restricting and providing access to multimedia. In some embodiments, the temporal restriction may be based on certain days of the week. For example, a certain DRM scheme may restrict access to multimedia during the days of Monday to Friday but allow access to those same multimedia items on Saturday and Sunday. Throughout the present disclosure, the term “multimedia item” may refer to certain channels, TV shows, movies, songs, pictures, and other multimedia items.

In other embodiments, a DRM system may be implemented to consider a user's profile and intelligently restrict and provide access to certain multimedia items based on a user's profile. A user's profile may be constructed using at least one machine-learning algorithm that may be trained on a user's previous multimedia viewing history. For example, a user may be subscribed to a certain temporal subscription for multimedia content (e.g., a subscription that permits a user to view certain multimedia only on the weekends). During the week, if the user desires to access certain multimedia items that are restricted, then the DRM system may intelligently provide an option for the user to access the restricted multimedia. This option from the DRM system may be provided in the form of a notification on a screen (i.e., a pop-up), and in some embodiments, the pop-up may request the user upgrade the user's subscription or pay a fee to access the restricted multimedia items.

In further embodiments, the DRM system may provide an option for a user to access specific multimedia items, like a certain live TV event (e.g., NFL football game, livestreamed concert, State of the Union address, etc.), that otherwise would be restricted to the user based on the user's subscription tier. This one-time access to a certain multimedia item may require a one-time fee from the user; in other embodiments, the multimedia item may be provided to the user as a complimentary multimedia item for that specified time.

To manage these different subscription tiers, certain data structures may be used. For instance, a hash table may be constructed with a link to a user profile, as well as a subscription tier indicator, that may be retrieved by the DRM system to then allow or restrict certain multimedia content based on the subscription tier. Accordingly, the present disclosure provides a plurality of technical benefits including but not limited to: construction of efficient data structures to manage different subscription models; reduce broadcast programming and network resources/bandwidth by implementing smart DRM systems; and reducing programming bloat by providing access to certain digital content on a user-specific basis based on machine-learning algorithms.

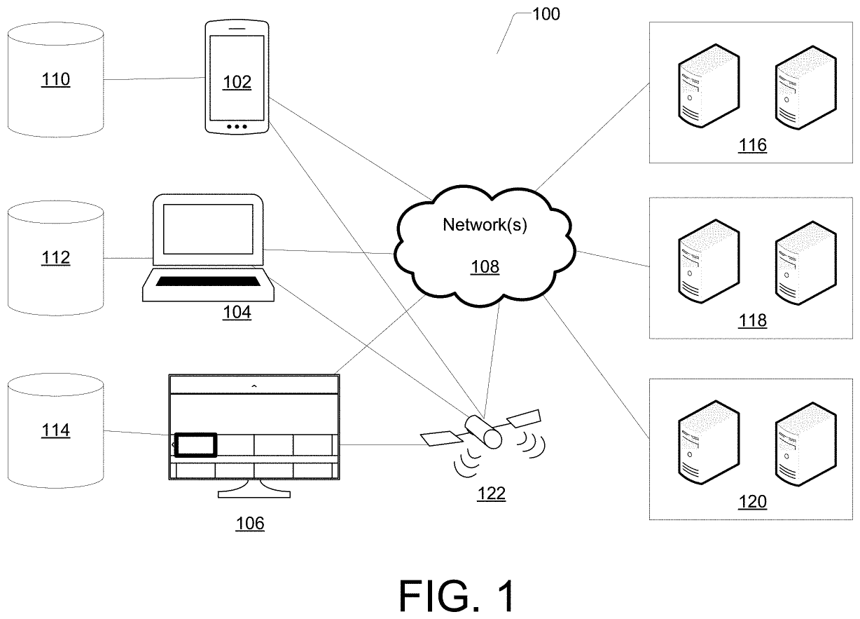

FIG. 1 illustrates an example of a distributed system for temporally restricting access to multimedia, as described herein. Example system 100 presented is a combination of interdependent components that interact to form an integrated whole for temporally restricting access to multimedia items. Components of the systems may be hardware components or software implemented on, and/or executed by, hardware components of the systems. For example, system 100 comprises client devices 102, 104, and 106, local databases 110, 112, and 114, network(s) 108, and server devices 116, 118, and/or 120.

Client devices 102, 104, and 106 may be configured to run a DRM program that provides and restricts access to certain multimedia items. In aspects, a client device, such as client devices 102, 104, and 106, may have access to one or more data sources and/or databases comprising multimedia content. In other aspects, client devices 102, 104, and 106, may be equipped to receive live broadband and/or satellite signals carrying multimedia items to be displayed on a display device, such as a television or client devices 102, 104, and 106. The signals that client devices 102, 104, and 106 may receive may be transmitted from satellite 122. Satellite 122 may also be configured to communicate with network(s) 108, in addition to being able to communicate directly with client devices 102, 104, and 106. In some examples, a client device may be a set-top box that is connected to a display device, such as a television (or a television that may have set-top box circuitry built into the television mainframe).

Client devices 102, 104, and 106 may be configured to run DRM software that may be stored locally on the client device or run remotely via network(s) 108. For example, a client device may receive a signal from satellite 122 containing a particular multimedia item to be displayed. The client device may attempt to play and display the multimedia item, but the DRM software may restrict access to this multimedia item based on, among other factors, the client device's current location, the current day/time, and a user's subscription level or tier. In alternative scenarios, the DRM application may be deployed via the cloud over network(s) 108 when client device(s) 102, 104, and 106 are connected to the Internet. The system may receive a certain request to display a multimedia item, but based on information received from a user's profile and subscription preferences (e.g., which may be accessed by the DRM application via remote server(s) 116, 118, and/or 120), the multimedia item may be restricted from display on the client device(s). If the client device(s) are offline, a local DRM application may be stored natively on the client device(s) 102, 104, and/or 106 in local databases 110, 112, and/or 114.

In some example aspects, the DRM application running on client device(s) 102, 104, and/or 106 may be configured to receive an electronic programming guide (EPG) via network(s) 108 and/or satellite 122. The EPG may display certain multimedia items that may be restricted to a user based on a user's subscription level, a timezone of a user device, a billing zip code of a user's profile, and/or a geographic location of a user device.

In yet further example aspects, the DRM system described herein may automatically and intelligently provide access to certain multimedia items based on at least one machine-learning algorithm trained on at least one dataset reflecting a user's multimedia viewing preferences. The at least one machine-learning algorithms (and models) may be stored locally at databases 110, 112, and/or 114 and/or externally at databases 116, 118, and/or 120. Client devices 102, 104, and/or 106 may be equipped to access these machine learning algorithms and intelligently select particular multimedia items to be displayed (e.g., for purchase and/or viewing, generally) based on at least one machine-learning model that is trained on a user's historical viewing history. For example, if a user frequently watches NFL football games, the user's viewing history may be collected to train a machine-learning model to then automatically provide certain digital items to the user for access during the temporal timeframes that the user would otherwise be restricted from accessing those certain digital items. Specifically, the DRM system may provide a user the option to view a Monday night football game that the user otherwise cannot view because the user's subscription level limits the user to viewing certain multimedia items to Saturday and Sunday. The DRM system may provide a pop-up to the user that describes how the user may access the currently restricted multimedia content. The user may be prompted to upgrade his/her subscription level and/or pay a one-time fee to view the multimedia item. In other example aspects, a user's viewing history may demonstrate a preference for certain genres, actors, time periods, geographies, etc. The DRM systems and methods described herein may implement at least one machine-learning algorithm that was trained on a dataset reflecting a user's preferences regarding genres, actors, time periods, and geographies, among other factors. The systems and methods described herein may then automatically select particular restricted multimedia items to display to the user if the user upgrades his/her subscription level, or, e.g., pays a one-time fee. Other multimedia items may include live events, such as livestreamed music concerts, political events (e.g., State of the Union address), holiday events (e.g., Thanksgiving parades, New Years' Eve, etc.), exclusive interviews with celebrities, as well as new episodes and seasons of television shows that a user may be inclined to watch based on the user's past viewing history and profile data.

As described herein, a machine-learning (ML) model may refer to a predictive or statistical utility or program that may be used to determine a probability distribution over one or more character sequences, classes, objects, result sets or events, and/or to predict a response value from one or more predictors. A model may be based on, or incorporate, one or more rule sets, machine learning, a neural network, or the like. In examples, the ML models may be located on the client device, service device, a network appliance (e.g., a firewall, a router, etc.), or some combination thereof. The ML models may process user viewing history and other data stores of user preferences (e.g., social media profiles) to determine which multimedia content should be presented to the user, or, in some examples, suggested to the user for purchase and viewing outside of the subscription timeframe (e.g., viewing multimedia items on weekdays when the subscription tier limits a user's viewing of multimedia items to the weekend). Determining whether a certain multimedia item should be presented by the DRM system may comprise identifying various characteristics of a user's viewing history and preferences. For instance, if a user has a social media profile that displays several photographs of the user engaging in sports, then the DRM system described herein may determine that certain program from sports channels (e.g., ESPN, NFL network) should be presented. Similarly, if a user posts certain social media items reflecting a favorite sports team, the DRM system may determine that games in which that specific team is playing should be presented (e.g., a certain football team is playing on a Monday night or a Thursday night, so the DRM system will prompt the user to view that multimedia item by upgrading his/her subscription level). Based on an aggregation of data from a user's viewing history, social media profiles, and other user data stores, at least one ML model may be trained and subsequently deployed to automatically suggest for presentation multimedia items that a particular user may enjoy viewing at a later time.

The trained ML model may be deployed to one or more devices. As a specific example, an instance of a trained ML model may be deployed to a server device and to a client device. The ML model deployed to a server device may be configured to be used by the client device when, for example, the client device is connected to the Internet. Conversely, the ML model deployed to a client device may be configured to be used by the client device when, for example, the client device is not connected to the Internet. In some instances, a client device may not be connected to the Internet but still configured to receive satellite signals with streaming information, multimedia information, and channel guides. In such examples, the ML model may be locally cached by the client device.

Because satellite 122 and network(s) 108 are configured to communicate with one another, the systems and methods described herein may be able to assess when a particular multimedia item is scheduled to air on live television (via satellite 122) or stream via an Internet-streaming service through network(s) 108. In such situations, the DRM system may initiate a notification beforehand (e.g., during the temporal timeframe the user has access to the multimedia content) to prompt the user to upgrade a subscription so the user may be able to view the upcoming multimedia item outside of the permitted timeframe of the user's subscription. The notification may display on a client device 102, 104, and/or 106 informing the user that the multimedia item is upcoming and is available for viewing by upgrading a certain subscription and/or remitting a one-time fee.

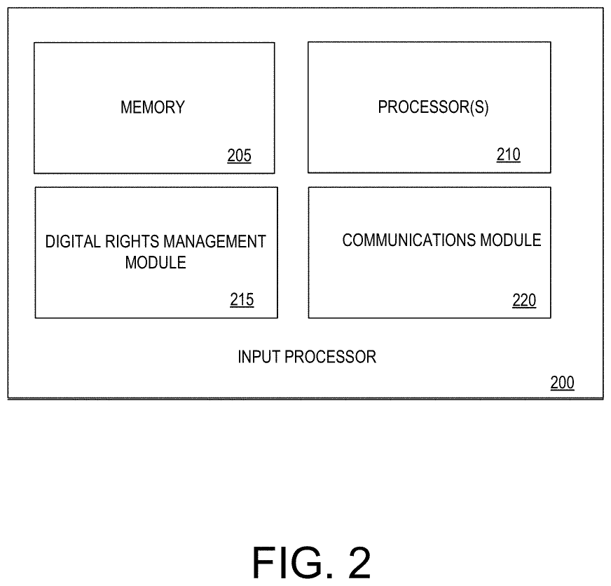

FIG. 2 illustrates an example input processor that is configured to implement the systems and methods described herein. Input processor 200 may be embedded within a client device (e.g., client devices 102, 104, and/or 106), remote web server device (e.g., devices 116, 118, and/or 120), set-top boxes, televisions, smart televisions, and other devices capable of running a DRM system for temporally restricting multimedia content. The input processing system contains one or more data processors and is capable of executing algorithms, software routines, and/or instructions based on processing data provided by a variety of sources related to the temporal restriction and accessibility of certain multimedia content (e.g., intelligently via a machine-learning algorithm and/or based on a subscription tier). The input processing system can be a factory-fitted system or an add-on unit to a particular device. Furthermore, the input processing system can be a general-purpose computer or a dedicated, special-purpose computer. No limitations are imposed on the location of the input processing system relative to a client, remote web server device, television, set-top box, etc. According to embodiments shown in FIG. 2, the disclosed system can include memory 205, one or more processors 210, digital rights management (DRM) module 215, and communications module 220. Other embodiments of the present technology may include some, all, or none of these modules and components, along with other modules, applications, data, and/or components. Still yet, some embodiments may incorporate two or more of these modules and components into a single module and/or associate a portion of the functionality of one or more of these modules with a different module.

Memory 205 can store instructions for running one or more applications or modules on processor(S) 210. For example, memory 205 could be used in one or more embodiments to house all or some of the instructions needed to execute the functionality of DRM module 215 and communications module 220. Generally, memory 205 can include any device, mechanism, or populated data structure used for storing information. In accordance with some embodiments of the present disclosures, memory 205 can encompass, but is not limited to, any type of volatile memory, nonvolatile memory, and dynamic memory. For example, memory 205 can be random access memory, memory storage devices, optical memory devices, magnetic media, floppy disks, magnetic tapes, hard drives, SIMMs, SDRAM, RDRAM, DDR, RAM, SODIMMs, EPROMs, EEPROMs, compact discs, DVDs, and/or the like. In accordance with some embodiments, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information that can be used as memory 205.

DRM module 215 may be configured to permit and restrict access to certain multimedia content based on a variety of factors. Some factors include, but are not limited to, days of the week, a geographic location of a user device, billing zip code of a user profile, a user's profile preferences, certain subject matter of multimedia content, and remittance of a fee, among other factors. DRM module 215 may be configured to store certain subscription values and user profiles in a data structure, such as a hash table. The hash table may be configured to organize certain users based on subscription tier. In one embodiment, the subscription tier of certain users may be denoted by a binary indicator (e.g., 0 or 1) to indicate if they have unlimited access to a certain set of multimedia content or no access to that set of multimedia content. Another column in the hash table may be a further binary indicator regarding a particular subscription type, such as a “weekend access” subscription type. In this column in the table, a further binary indicator may indicate if a user is a “weekend access” subscriber or not. When providing multimedia content to a user's device, DRM module 215 may refer to a hash table to determine which multimedia content may be accessible by a user and when that multimedia content may be accessible by the user.

In further embodiments, DRM module 215 may be configured with at least one ML engine that can receive user viewing history and other user profile data to train at least one machine-learning model or compare user viewing history and profile data against an already-trained machine-learning model. For example, to train the ML model(s), the extracted features of the input data may be associated with specific multimedia identifiers (e.g., director, writer, genre, geography, actor/actresses, etc.). The ML engine may utilize various machine learning algorithms to train the ML model, including but not limited to linear regression, logistic regression, linear discriminant analysis, classification and regression trees, naïve Bayes, k-Nearest neighbors, learning vector quantization, neural networks, support vector machines (SVM), bagging and random forest, and/or boosting and AdaBoost, among other supervised and unsupervised machine learning algorithms. The aforementioned machine learning algorithms may also be applied when comparing input data to an already-trained machine learning model. Based on the identified and extracted multimedia features and patterns (e.g., user viewing patterns), ML engine may select the appropriate machine learning algorithm to apply to the multimedia features to train the at least one machine learning model. For example, fi the received multimedia features are complex and demonstrate non-linear relationships, then ML engine may select a bagging and random forest algorithm to train the machine learning model. However, if the multimedia features demonstrate a linear relationship to certain multimedia features and input data (e.g., user viewing history), then ML engine may apply a linear or logistic regression algorithm to train the machine learning model.

In other aspects, the ML engine incorporated within the DRM module 215 may apply at least one already-trained machine learning model to the received multimedia features from the past user viewing history and other user profile data to detect previously identified and extracted multimedia features (e.g., certain actors the user may enjoy watching in movies or television shows) and previously recognized patterns (e.g., user enjoys NFL football). ML engine may be configured to compare at least one trained machine learning model to the received input data to generate comparison results that indicate which multimedia items should be presented to the user during the temporal timeframe the user does not have access to certain multimedia content based on the user's subscription tier and based on the user's preferences. Specifically, ML engine may compare the identified and extracted multimedia features of the multimedia items from the user viewing history that are associated with specific multimedia identifiers. ML engine is also configured to generate comparison results, indicating the similarity (or lack thereof) between certain multimedia assets on which the machine learning model was trained and the received multimedia features. In other aspects, the comparison results may include a confidence indicator, which may indicate how confident the system may be that a candidate multimedia item is relevant to the user. For instance, based on the user viewing history and other user profile data, a confidence score may be assigned to certain candidate multimedia items to be displayed (e.g., via a pop-up notification). In one example, candidate multimedia items that are scored with a confidence indicator above a certain threshold may be presented to the user, whereas those below the threshold may not be presented (e.g., multimedia items with an “8/10” or higher on the confidence score may be displayed to the user as an option to view during restricted viewing times). It should be appreciated that DRM module 215 (which houses the ML engine) is configured to communicate with communications module 220.

Communications module 220 is associated with sending/receiving information (e.g., collected by DRM module 215, such as commands received via client devices or remotes, navigation history within the EPG, etc.) with other client devices, remote web servers, set-top boxes, televisions, remotes, etc. These communications can employ any suitable type of technology, such as Bluetooth, WiFi, WiMax, cellular (e.g., 5G), single hop communication, multi-hop communication, Dedicated Short Range Communications (DSRC), or a proprietary communication protocol. In some embodiments, communications module 220 sends information received by DRM module 215 to client device(s) 102, 104, and/or 106, as well as remote server(s) 116, 118, and/or 120 via network(s) 108 and/or satellite 122. In other examples, communications module 220 may communicate a command to DRM module 215 that is received from a client device, remote web server, remote, television, and/or other mechanism initiating a command to display, navigate, and/or dismiss an EPG.

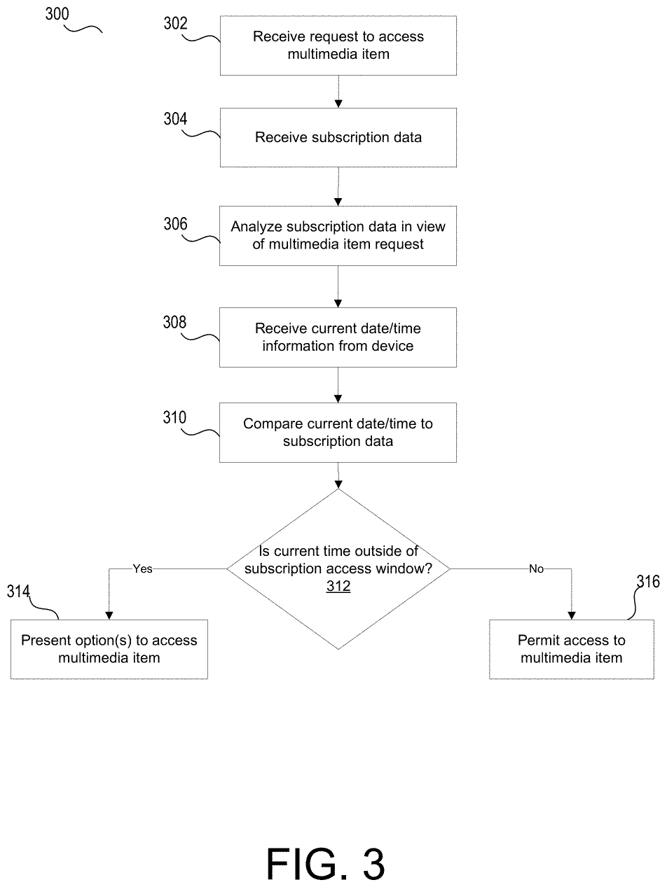

FIG. 3 illustrates an example method for temporally restricting multimedia. Method 300 begins with receiving a request to access a multimedia item at step 302. In one embodiment, the request may be received during the permitted timeframe based on the subscription or it may be received outside the time of the permitted subscription timeframe. The request may be received via an EPG, where the system receives an indication to play a certain multimedia item. After receiving the request to play the multimedia item, the system then analyzes subscription data associated with the user profile that may be currently logged into the multimedia system (e.g., account that has purchased broadcast/satellite television services, or user account on an Internet-streaming service). The subscription data may be received by the system at step 304. The subscription data may be analyzed at step 306 in view of the request to play the multimedia item. For example, the subscription may be a temporal subscription that restricts a user from viewing certain multimedia items during the week (Monday through Friday). As such, the system may prevent the user from playing the multimedia item on the device if the request is received during the week. At step 308, the system receives the current day and time of the device and checks that current date and time information against the subscription data at step 310. At decision diamond 312, the system determines if the current date and time fall within a permitted or restricted timeframe based on the subscription data. If the request to play the multimedia item is received during a permitted timeframe (e.g., Saturday or Sunday), then the multimedia item may be played at step 316. Access to the multimedia item is granted to the user. However, if the request is received outside of the permitted subscription timeframe, then the multimedia item may be restricted. In some embodiments, in the scenario where a user is desiring to view a multimedia item that is restricted, the system may present an option to access the multimedia item (Step 314). This option to access the multimedia item may be in the form of a pop-up notification on the EPG that allows the user to instantaneously upgrade his/her subscription tier to a tier that would permit access to that multimedia item at that particular time. In other examples, the option to access the multimedia item may be in the form of a notification that prompts the user to pay a one-time fee to access that one multimedia item for a preset duration (e.g., 24 hours) or until the programming is finished (e.g., access to a live football game that will end in ˜4 hours).

In yet other embodiments, the DRM system described herein may provide notifications to a user during a permitted timeframe (e.g., while a user is watching accessible multimedia content) that prompt the user to preemptively gain access to certain multimedia content that will be restricted in the future under the user's current subscription tier. For example, a user who is watching a football game on Sunday and has a weekend-only subscription package, may receive from the DRM system an intelligent notification to upgrade his or her subscription tier so that the user can view an upcoming football game on Monday night (which would be restricted under the user's current subscription tier). The notification may be generated by the DRM system based on at least one ML model that is trained on the user's past viewing history. For example, if the user frequently watches football on the weekend, then a notification to prompt the user to watch a football game during the week may be generated by the DRM system based on the ML model. If a user frequently watches music event son the weekend, then a livestreamed concert event occurring during the week may be of interest to the user according to the ML model. The ML model may provide the suggestion to the DRM system, which may then generate a notification to the user to upgrade the user's subscription in order to access that multimedia item during the week.

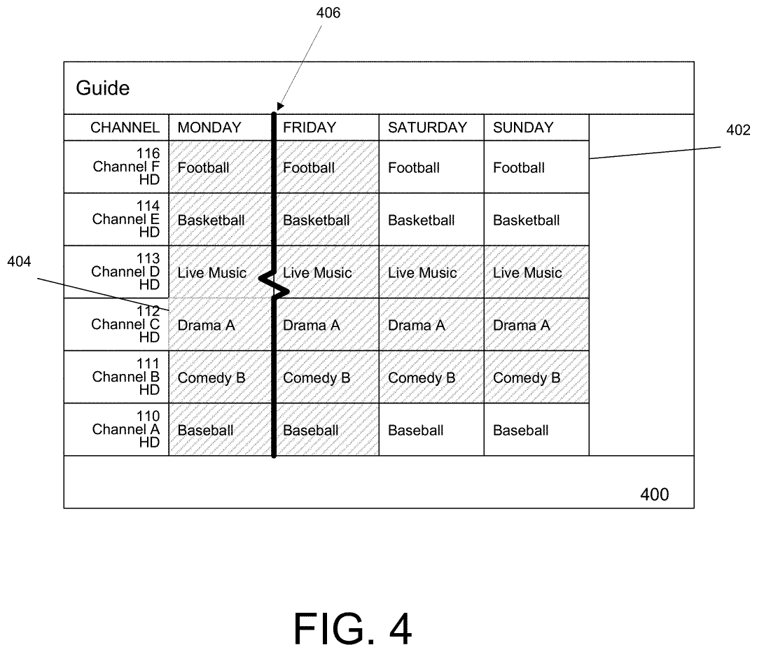

FIG. 4 illustrates an example electronic program guide indicating accessibility of certain multimedia items based on the systems and methods disclosed herein. The EPG 400 displays several grayed out (or inaccessible, restricted) channels. The break 406 represents the days Tuesday to Thursday on the channel guide. In this scenario, a user may have a weekend access subscription limited to sports channels. As such, a user may be able to access a Football channel 402 on Saturday and Sunday, as well as a Basketball channel and Baseball channel. However, on the weekends, a user may be restricted from accessing a Drama A channel 404. Based on this subscription tier described in FIG. 4, a user may not have access to drama, live music, or comedy shows on any day of the week. Based on user profile information received by the DRM system described herein, the DRM system may provide pop-up notifications to the user, prompting the user to upgrade his/her subscription tier so that the user may obtain access to certain channels (e.g., on the weekend only, during the week, on certain weekdays, at certain times of day, unlimited access to certain channels, etc.). For example, the DRM system described herein may have received user profile information indicating that a user has recently been viewing comedy shows online. The user profile data may be used by the DRM system to create a certain subscription package for the user that allows the user access to the comedy channel on the weekend, along with the sports package the user already has access to. The DRM system may present this specialized subscription offer to the user via a notification on a graphical user interface, wherein the user may elect to accept an upgrade or dismiss the notification.

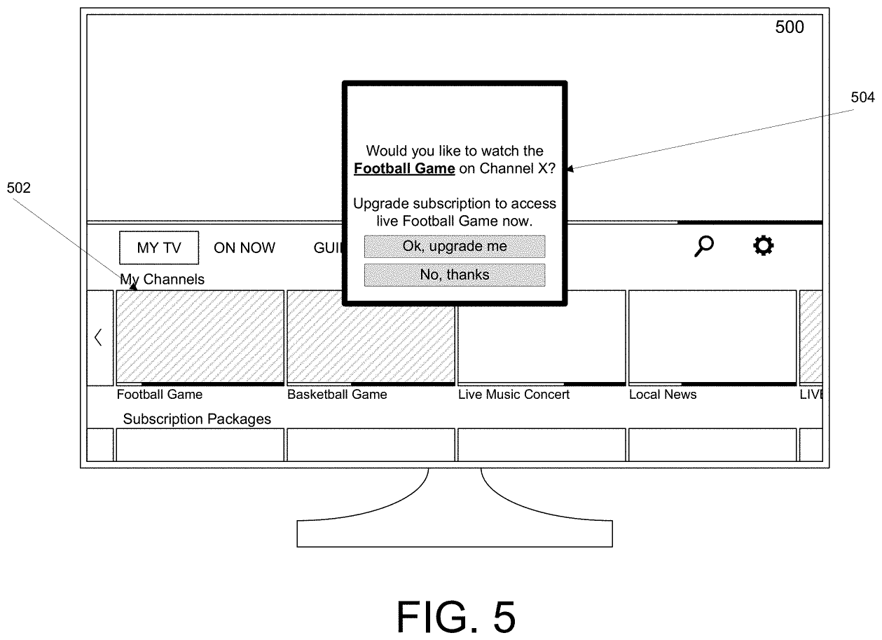

FIG. 5 illustrates an example display device with an electronic program guide indicating accessibility of certain multimedia items based on the systems and methods disclosed herein. Display device 500 includes a list of “My Channels” including a Football Game 502, which is grayed out, indicating that the multimedia item is restricted from viewing. This may be due to the current date and time the user is desiring to access the multimedia item. If, for example, the date and time are outside the permitted timeframe based on the user's subscription, then the user may be unable to access that multimedia item. In this instance, a user may select the football game 502, and the system may display a notification 504 that prompts the user to upgrade the user's subscription in order to watch the live football game 502. The user may select “Ok, upgrade me” or “No, thanks.” In other embodiments, the notification 504 may be displayed automatically when the user turns on the display device 500 because the system may determine, based on the output from at least one ML model trained on a user's past viewing history and profile characteristics, that the user is likely interested in viewing the live football game 502.

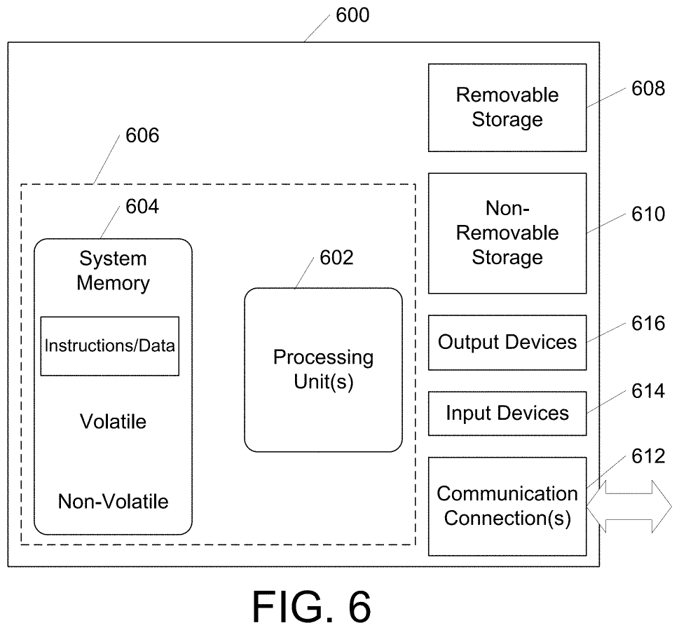

FIG. 6 illustrates one example of a suitable operating environment in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 600 typically includes at least one processing unit 602 and memory 604. Depending on the exact configuration and type of computing device, memory 604 (storing, among other things, information related to devices, blockchain networks, service performance indicators, remedial actions, and instructions to perform the methods disclosed herein) may be volatile (such as RAM), non-volatile (such as ROM, flash memory, etc.), or some combination of the two. This most basic configuration is illustrated in FIG. 6 by dashed line 606. Further, environment 600 may also include storage devices (removable 608 and/or non-removable 610) including, but not limited to, magnetic or optical disks or tape. Similarly, environment 600 may also have input device(s) 614 such as keyboard, mouse, pen, voice input, etc., and/or output device(s) 616 such as a display, speakers, printer, etc. Also included in the environment may be one or more communication connections, 612, such as Bluetooth, WiFi, WiMax, LAN, WAN, point to point, etc.

Operating environment 600 typically includes at least some form of computer readable media. Computer readable media can be any available media that can be accessed by processing unit 602 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures (e.g., blockchains), program modules or other data. Computer storage media includes, RAM, ROM EEPROM, flash memory or other memory technology, CD-ROM, digital versatile disks (DVD) or other optical storage, magnetic cassettes, magnetic tape, magnetic disk storage, or other magnetic storage devices, or any other tangible medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulate data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The operating environment 600 may be a single computer (e.g., mobile computer) operating in a networked environment using logical connections to one or more remote computers. The remote computer may be a personal computer, a server, a router, a network PC, a peer device, an OTA antenna, a set-top box, or other common network node, and typically includes many or all of the elements described above as well as others not so mentioned. The logical connections may include any method supported by available communications media. Such networking environments are commonplace in offices, enterprise-wide computer networks, intranets, and the Internet.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of the claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and the alternate aspects falling within the spirit of the broader aspects of the general inventive concept embodied in this application that do not depart from the broader scope of the claimed disclosure.

From the foregoing, it will be appreciated that specific embodiments of the invention have been described herein for purposes of illustration, but that various modifications may be made without deviating from the scope of the invention. Accordingly, the invention is not limited except as by the appended claims.

What is claimed is:

1. A system for temporally restricting multimedia content, comprising:
a memory configured to store non-transitory computer readable instructions; and
a processor communicatively coupled to the memory, wherein the processor, when executing the non-transitory computer readable instructions, is configured to:
receive, from a multimedia device, a request to access at least one multimedia item;
receive subscription data associated with at least one user profile;
analyze subscription data in view of the request to access at least one multimedia item;
receive current date and time data from the multimedia device;
compare the current date and time data to the subscription data; and
based on the comparison of the current date and time data to the subscription data, restrict access to the at least one multimedia item.

2. The system of claim 1, the processor further configured to:
present for display on the multimedia device a notification associated with the at least one multimedia item, wherein the notification presents at least one method of accessing the at least one multimedia item.

3. The system of claim 1, wherein the at least one multimedia item is at least one of: a television show, a movie, a sporting event, a live event, a song, a concert, a picture, and a video.

4. The system of claim 2, the processor further configured to:
receive an input associated with the notification, wherein the input indicates acceptance of the at least one method of accessing the at least one multimedia item; and
based on the acceptance of the at least one method of accessing the at least one multimedia item, permit access to the at least one multimedia item.

5. The system of claim 2, wherein the at least one method of accessing the at least one multimedia item is an option to upgrade a subscription.

6. The system of claim 2, wherein the at least one method of accessing the at least one multimedia item is an option to pay a one-time fee.

7. The system of claim 2, the processor further configured to:
analyze at least one machine-learning model, wherein the at least one machine-learning model is trained on data based on the at least one user profile.

8. The system of claim 7, wherein the at least one machine-learning model is trained according to at least one of: a linear regression, a logistic regression, a linear discriminant analysis, a regression tress, a naïve Bayes algorithm, a k-nearest neighbors algorithm, a learning vector quantization, a neural network, a support vector machine (SVM), and a random forest.

9. The system of claim 7, wherein the data based on the at least one user profile comprises a past viewing history associated with the at least one user profile.

10. The system of claim 7, the processor further configured to:
present for display on the multimedia device a notification associated with a second multimedia item, wherein the second multimedia item is selected by the at least one machine-learning model.

11. The system of claim 1, wherein the subscription data comprises a permitted timeframe for accessing multimedia items.

12. The system of claim 11, wherein the permitted timeframe for accessing multimedia items is the weekend.

13. A method for temporally restricting access to multimedia content, comprising:
receiving, from a multimedia device, a request to access at least one multimedia item;
receiving subscription data associated with at least one user profile;
analyzing subscription data in view of the request to access at least one multimedia item;
receiving current date and time data from the multimedia device;
comparing the current date and time data to the subscription data; and
based on the comparison of the current date and time data to the subscription data, permitting access to the at least one multimedia item.

14. The method of claim 13, further comprising:
analyzing at least one machine-learning model, wherein the at least one machine-learning model is trained on data based on the at least one user profile.

15. The method of claim 14, further comprising:
based on the analysis of the at least one machine-learning model, presenting for display on the multimedia device a notification associated with a second multimedia item.

16. The method of claim 15, wherein the second multimedia item is a restricted multimedia item at a future data and time.

17. The method of claim 15, wherein the notification presents at least one method of accessing the second multimedia item.

18. The method of claim 17, wherein the at least one method of accessing the second multimedia item is an option to upgrade a subscription.

19. The method of claim 17, wherein the at least one method of accessing the second multimedia item is an option to pay a one-time fee.

20. A computer-readable media storing non-transitory computer executable instructions that when executed cause a computing system to perform the steps of:
receiving, from a multimedia device, a request to access at least one multimedia item;
receiving subscription data associated with at least one user profile;
analyzing subscription data in view of the request to access at least one multimedia item;
receiving current date and time data from the multimedia device;
comparing the current date and time data to the subscription data;
based on the comparison of the current date and time data to the subscription data, restricting access to the at least one multimedia item;
presenting for display on the multimedia device a notification associated with the at least one multimedia item, wherein the notification presents an option to upgrade a subscription to access the at least one multimedia item;
receiving an input associated with the notification, wherein the input indicates acceptance of the option to upgrade the subscription; and
permitting access to the at least one multimedia item.
